(19) United States
(12) Patent Application Publication
(10) Pub. No.: US 2019/0184944 A1
(43) Pub. Date: Jun. 20, 2019

(54) AIR CONDITIONING DEVICE FOR VEHICLE HAVING VACUUM CLEANING FUNCTION AND CONTROL METHOD THEREOF

(71) Applicants: Hyundai Motor Company, Seoul (KR); Kia Motors Corporation, Seoul (KR); Doowon Climate Control Co., Ltd., Asan (KR)

(72) Inventors: Yong-Chul Kim, Hwaseong (KR); Jong-Heon Lee, Suwon (KR); Jun-Sic Jung, Asan (KR)

(21) Appl. No.: 16/178,182

(22) Filed: Nov. 1, 2018

(30) Foreign Application Priority Data
Dec. 15, 2017 (KR) 10-2017-0173476

(51) Int. Cl. B60S 1/64; B60H 1/00; A47L 5/38; A47L 7/00; A47L 9/00; A47L 9/16

(52) U.S. Cl. CPC B60S 1/64; B60H 1/00028; B60H 1/00428; A47L 9/1683; A47L 5/38; A47L 7/0076; A47L 9/0072; B60H 1/00442

(57) ABSTRACT

An air conditioning device for a vehicle includes a main body, a blower provided in the main body, a suction part connected to one side of the main body to draw in outdoor air, and an exhaust part connected to the suction part to exhaust air.

### CROSS-REFERENCE TO RELATED APPLICATION(S)

This application claims under 35 U.S.C. § 119(a) the benefit of Korean Patent Application No. 10-2017-0173476, filed on Dec. 15, 2017, the entire contents of which are incorporated herein by reference.

### BACKGROUND

### (a) Technical Field

The present disclosure relates to an air conditioning device for a vehicle having a vacuum cleaning function and a control method thereof, more particularly, to the air conditioning device and the control method that may simultaneously implement an air conditioning function and a cleaning function by adding the cleaning function to a rear heating, ventilating and air conditioning (HVAC) system.

### (b) Description of Related Art

Generally, a cooling and heating apparatus for a vehicle appropriately maintains an air environment including temperature and humidity according to a change in ambient temperature, and in such a cooling and heating apparatus, a heating, ventilating and air conditioning (HVAC) system is mounted in the vehicle in order to provide a comfortable environment to a user (i.e., driver and/or other occupants) by performing various air conditioning functions such as interior ventilation, cooling and heating, and removal of frost or the like by operation of the user.

The HVAC system includes an air inhaler and an air exhauster, and performs heating, ventilating, and air conditioning in the interior of a vehicle according to a temperature sensed by a temperature sensor installed at a tip end of an air suction pipe of the air inhaler or a temperature sensor installed at a rear end of an air exhaust pipe of the air exhauster, or the like.

Specifically, the HVAC system includes a fan blowing air, an evaporator for cooling the air, and a heater for heating the air, in which the fan blows external or indoor air to the evaporator or the heater to supply the air to the interior of the vehicle through a vent portion forming an air vent.

In addition, the evaporator is disposed at a rear side of the fan, and absorbs heat included in the air using a refrigerant condensed in a condenser and expanded in an expansion valve to cool the air.

The heater is positioned at a rear side of the evaporator, and in the heater, a coolant flows so as to cool a cylinder block of an engine to be heated to have an increased temperature flows, and the coolant of the heater heats the air drawn into the HVAC module to make the air warm.

Further, the air conditioning device of the vehicle is positioned in a dash panel from a passenger's seat to a central portion of the vehicle, and in the air conditioning device, an evaporator for cooling, a heater for heating, and a blower unit for optional blowing of indoor air or outdoor air are positioned.

Particularly, in a vehicle, a separate air conditioning device is installed in the vehicle to maintain comfortable atmosphere in the interior of the vehicle. The air conditioning device circulates indoor air or introduces outdoor air in a process of cooling or heating air in the vehicle, thus a filter is installed for filtering out foreign materials such as dust included in the indoor air or the outdoor air.

Meanwhile, when the vehicle is driven in the rain, even though doors and glass windows are closed, moisture and rainwater are introduced into the vehicle due to passengers getting into the vehicle from the outside and thus a floor in the vehicle is often made dirty by dirt and refuse from the ground. As a result, an odor which is harmful to a human caused by fungi or the like may be produced and the interior of the vehicle may be soiled, and various dust including the contaminants are main causes that make air in the vehicle stale.

FIG. 1 (RELATED ART) is a schematic view of an HVAC system for a vehicle and a cleaner according to the related art.

FIG. 1 illustrates an HVAC system 10 for a vehicle and a separate cleaner 20 for cleaning the interior of the vehicle.

As such, in order to remove contaminants or dust in the vehicle, most vehicles are equipped with a portable vacuum cleaner using a battery power supply of the vehicle to clean the interior of the vehicle using suction to remove dust when needed. However, it is very inconvenient to equip the vehicle with the cleaner, and the use of the cleaner is inconvenient.

Further, a general cleaner only has suction and does not have a function of blowing dust, and thus a separate blowing machine is needed.

### SUMMARY

An embodiment of the present disclosure is directed to an air conditioning device for a vehicle and a control method thereof that may simultaneously implement an air conditioning function and a cleaning function to improve convenience, may allow the vehicle not to include separate cleaning equipment to increase economical efficiency, may not occupy a space for storing cleaning equipment to improve space utilization, and may reduce a weight.

Other objects and advantages of the present disclosure can be understood by the following description, and become apparent with reference to the embodiments of the present disclosure. Also, it is obvious to those skilled in the art to which the present disclosure pertains that the objects and advantages of the present disclosure can be realized by the means as claimed and combinations thereof.

In accordance with an embodiment of the present disclosure, an air conditioning device for a vehicle includes: a main body; a blower provided in the main body; a suction part connected to one side of the main body to draw in outdoor air; and an exhaust part connected to the suction part to exhaust air.

The suction part may include a suction case, a suction door embedded in the suction case to selectively open or close a channel, a suction actuator configured to open or close the suction door, a dust container connected to the suction case, and a suction filter embedded in the dust container.

The suction door may selectively open one of an outdoor air suction channel and an indoor air suction channel.

The suction filter may be a washable filter.

A suction hose connecting part may be provided at the dust container.

The suction hose connecting part may be formed with a first protrusion.

The suction hose connecting part may be a rotation locking structure.

The suction part may further include a first cover covering the suction part.

The exhaust part may include an exhaust case, an exhaust door connected to the exhaust case to open or close an exhaust channel, an exhaust actuator configured to open or close the exhaust door, and an exhaust filter embedded in the exhaust case.

An exhaust hose connecting part may be provided at the exhaust case.

The exhaust hose connecting part may be a rotation locking structure.

The exhaust part may further include a second cover covering the exhaust part.

A vacuum cleaner using the air conditioning device may further include a cleaning hose.

A recessed groove corresponding to a rotation locking structure may be formed in a coupling portion of the cleaning hose.

A vacuum cleaner using the air conditioning device may further include a control panel.

The control panel may include an air conditioning mode button, a cleaning suction button, and a cleaning blowing button.

The control panel may further include a blower button.

The control panel may further include an air conditioning temperature button.

In accordance with another embodiment of the present disclosure, a control method of a vacuum cleaner using an air conditioning device for a vehicle, where the air conditioning device includes a main body, a blower provided in the main body, a suction part connected to one side of the main body to draw in outdoor air; and an exhaust part connected to the suction part to exhaust air, the control method includes: (a) selecting one of an air conditioning mode button, a cleaning suction button, and a cleaning blowing button in a control panel; and (b) adjusting an air channel according to a mode corresponding to the button selected from the air conditioning mode button, the cleaning suction button, and the cleaning blowing button.

In the selecting step, when the air conditioning mode button is pressed, a suction door and an exhaust door may be closed, and indoor air may be introduced.

In the selecting step, when the cleaning suction button is pressed, the suction door may be opened, an indoor air suction channel may be closed, and the exhaust door may be closed.

In the selecting step, when the cleaning blowing button is pressed, the suction door may be closed, the indoor air suction channel may be opened, and the exhaust door may be opened.

### BRIEF DESCRIPTION OF THE DRAWINGS

FIG. 1 (RELATED ART) is a schematic view of a heating, ventilating and air conditioning (HVAC) system for a vehicle and a cleaner according to the related art.

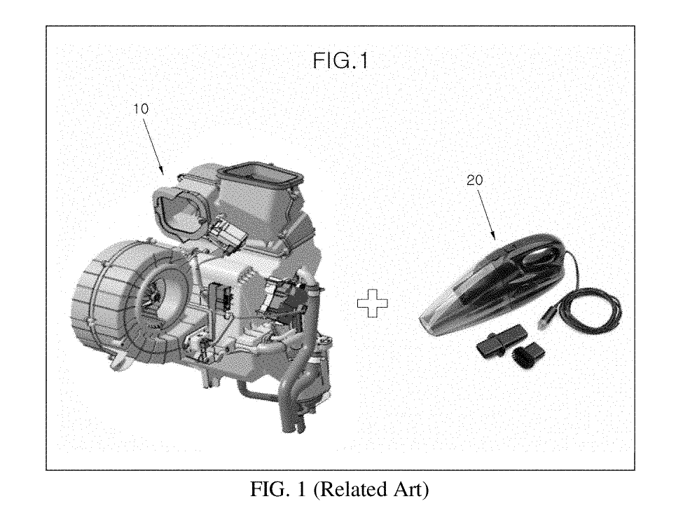

FIG. 2 is a perspective view of an air conditioning device for a vehicle according to an embodiment of the present disclosure.

FIG. 3 is a plan view and a front view of the air conditioning device according to the embodiment of the present disclosure in FIG. 2.

FIG. 4 is a schematic view of a suction hose connecting part of the air conditioning device according to the embodiment of the present disclosure.

FIG. 5 is a schematic view of a control panel of the air conditioning device according to the embodiment of the present disclosure.

FIG. 6 is a schematic view of an air conditioning mode of the air conditioning device according to the embodiment of the present disclosure.

FIG. 7 is a schematic view of a cleaning suction mode of the air conditioning device according to the embodiment of the present disclosure.

FIG. 8 is a schematic view of a cleaning blowing mode of the air conditioning device according to the embodiment of the present disclosure.

### DESCRIPTION OF SPECIFIC EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Embodiments described hereinbelow are provided for a person skilled in the art to readily understand a technical idea of the present disclosure, and the present disclosure is not limited by the embodiments. Further, matters expressed in the accompanying drawings are illustrated to facilitate explanation of the embodiments of the present disclosure and may be different from an actually implemented form.

It is to be understood that when one element is referred to as being “connected to” or “coupled to” another element, it may be connected directly to or coupled directly to another element or be connected to or coupled to another element, having the other element intervening therebetween.

Further, the term “connection” used herein may include direct connection and indirect connection between one member and another member, and may mean all physical connection such as adhesion, attachment, fastening, bonding, coupling, and the like.

Further, expressions such as “first” and “second” are expressions used only to distinguish a plurality of components, thus do not limit an order among the components or other features of the components.

Singular forms are intended to include plural forms unless the context clearly indicates otherwise. Terms “include” or “have” used in this specification are to specify the presence of stated features, numerals, steps, operations, components, parts, or a combination thereof, and it may be construed that addition of one or more other features, numerals, steps, operations, components, parts, or a combination thereof is possible.

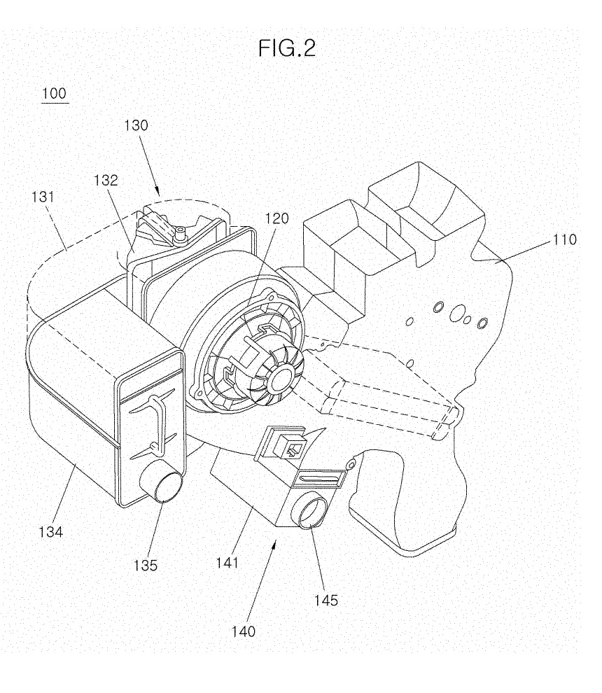

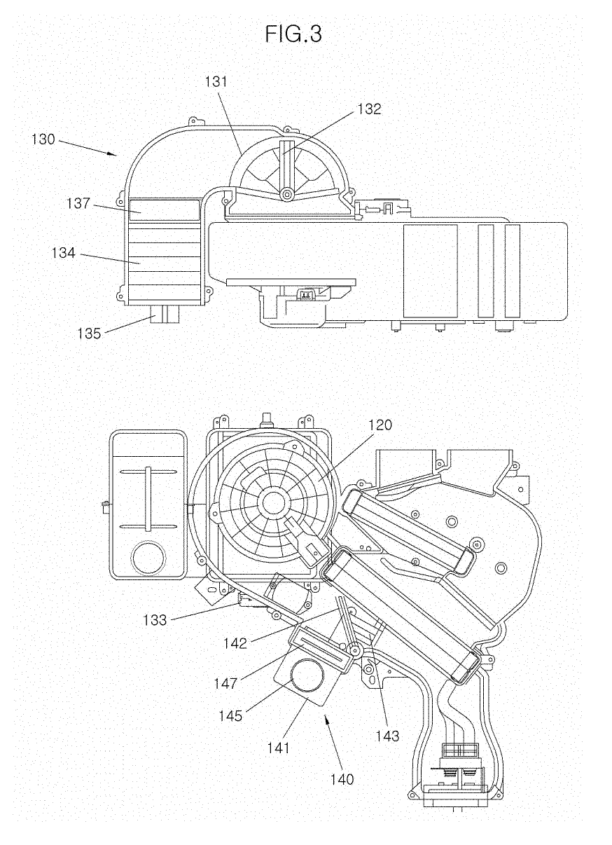

FIG. 2 is a perspective view of an air conditioning device for a vehicle according to an embodiment of the present disclosure and FIG. 3 is a plan view and a front view of the air conditioning device according to the embodiment of the present disclosure in FIG. 2.

Referring to FIGS. 2 and 3, an air conditioning device 100 according to an embodiment of the present disclosure includes a main body 110, a blower 120 provided in the main body 110, a suction part 130 connected to one side of the main body 110 to draw in outdoor air, and an exhaust part 140 connected to the suction part 130 to exhaust air.

In an embodiment, the suction part 130 includes a suction case 131, a suction door 132 embedded in the suction case 131 to selectively open or close a channel, a suction actuator 133 configured to open or close the suction door 132, a dust container 134 connected to the suction case 131, and a suction filter 137 embedded in the dust container 134, and may further include a first cover covering the suction part 130.

In this embodiment, the suction door 132 selectively opens one of an outdoor air suction channel and an indoor air suction channel, and the selective opening of the suction door 132 is performed according to a control mode. Thus, an operational relationship according to the control mode will be described below in detail.

The suction case 131 according to the present disclosure has one end connected to the dust container 134, and the suction filter 137 is embedded in the dust container 134. The suction filter 137 preferably is a washable filter and may be repeatedly used.

Meanwhile, a suction hose connecting part 135 is provided at the dust container 134. A cleaning hose is coupled to the suction hose connecting part 135, and the coupling structure is a rotation locking structure.

In an embodiment, the exhaust part 140 includes an exhaust case 141, an exhaust door 142 connected to the exhaust case 141 to open or close an exhaust channel, an exhaust actuator 143 configured to open or close the exhaust door 142, and an exhaust filter 147 embedded in the exhaust case 141. In addition, a second cover may be included so as to cover the exhaust part 140.

An exhaust hose connecting part 145 is provided at the exhaust case 141 according to the present disclosure. A cleaning hose is coupled to the exhaust hose connecting part 145, and the coupling structure is a rotation locking structure like the coupling structure of the suction hose connecting part 135.

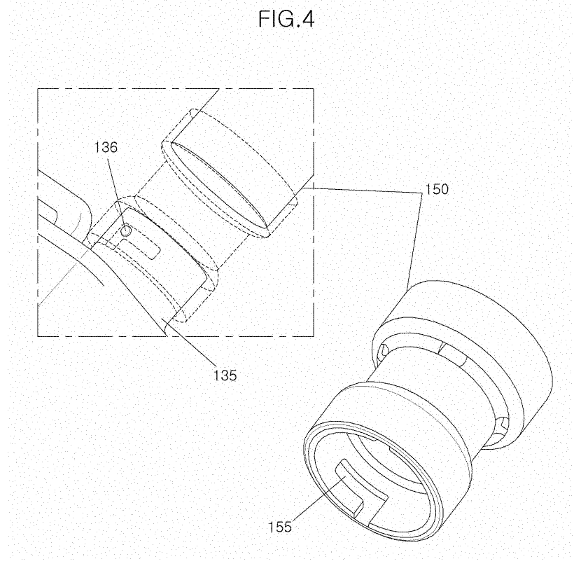

FIG. 4 is a schematic view of a suction hose connecting part of the air conditioning device according to the embodiment of the present disclosure.

Referring to FIG. 4 together with FIGS. 2 and 3, the coupling structure for the suction hose connecting part is illustrated. The dust container 134 is coupled to the suction case 131, the suction hose connecting part 135 is provided at the dust container 134, and the cleaning hose is coupled to the suction hose connecting part 135.

The suction hose connecting part 135 is formed with a first protrusion 135 for coupling with the cleaning hose 150, and the cleaning hose 150 is formed with a recessed groove 155. The coupling structure is a rotation locking structure, in which the first protrusion 136 of the suction hose connecting part 135 and the recessed groove 155 of the cleaning hose 150 are coupled to each other and fixed.

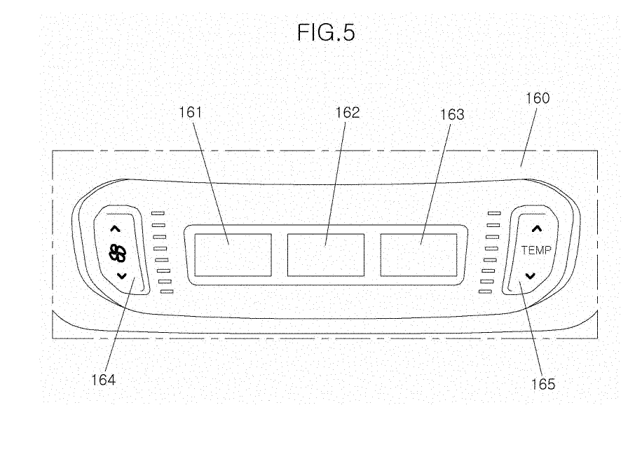

FIG. 5 is a schematic view of a control panel of the air conditioning device according to the embodiment of the present disclosure.

Referring to FIG. 5, the air conditioning device having a vacuum cleaning function according to the present disclosure further includes a control panel 160.

The control panel 160 includes an air conditioning mode button 161, a cleaning suction button 162, and a cleaning blowing button 163, and to further include a blower button 164 for adjusting a strength of wind and an air conditioning temperature button 165 for adjusting a temperature.

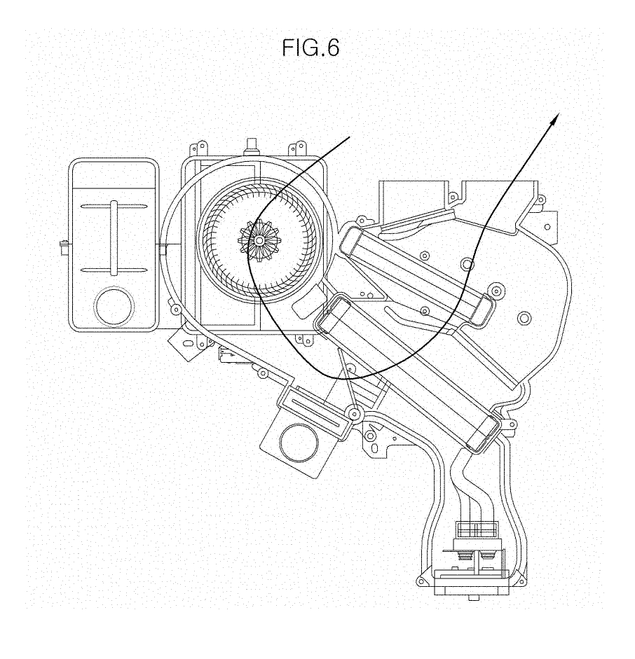

FIG. 6 is a schematic view of an air conditioning mode of the air conditioning device according to the embodiment of the present disclosure.

Referring to FIG. 6 together with FIGS. 2 to 5, an operational relationship and a control method in a case in which the air conditioning mode button 161 of the air conditioning device according to the embodiment of the present disclosure is pressed will be described. First, one of the air conditioning mode button 161, the cleaning suction button 162, and the cleaning blowing button 163 is selected in the control panel, and then an air channel is adjusted according to a mode corresponding to the button selected from the air conditioning mode button 161, the cleaning suction button 162, and the cleaning blowing button 163, and when the air conditioning mode button 161 is pressed, the suction door and the exhaust door are closed, and the indoor air is introduced.

Specifically, the air conditioning device 100 according to the embodiment of the present disclosure includes the main body 110, the blower 120 provided in the main body 110, the suction part 130 connected to one side of the main body 110 to draw in outdoor air, and the exhaust part 140 connected to the suction part 130 to exhaust air, the suction part 130 includes the suction case 131, the suction door 132 embedded in the suction case 131 to selectively open or close a channel, the suction actuator 133 configured to open or close the suction door 132, the dust container 134 connected to the suction case 131, and the suction filter 137 embedded in the dust container 134, and the suction door 132 selectively opens one of the outdoor air suction channel and the indoor air suction channel. When the air conditioning mode button 161 is pressed, the outdoor air suction channel is closed, and the indoor air suction channel is opened.

Further, the exhaust part 140 includes the exhaust case 141, the exhaust door 142 connected to the exhaust case 141 to open or close the exhaust channel, the exhaust actuator 143 configured to open or close the exhaust door 142, and the exhaust filter 147 embedded in the exhaust case 141, and the exhaust channel is closed by closing the exhaust door 142.

Accordingly, the air flows through the indoor air suction channel communicating with one side of the suction case 131 as shown by an arrow, and flows into the interior through the main body 110 since the exhaust door 142 is closed.

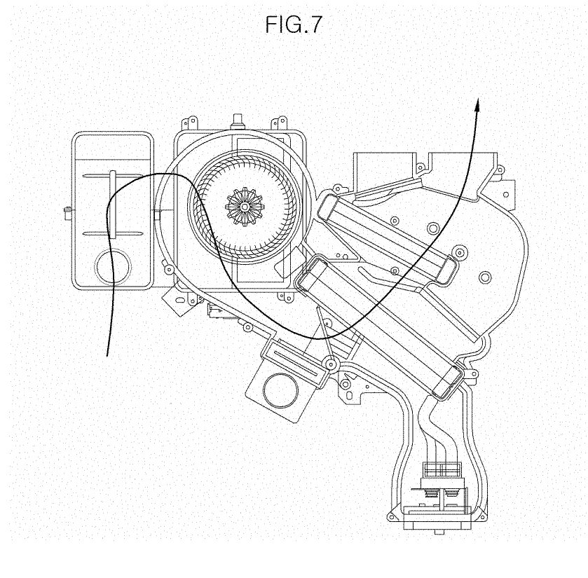

FIG. 7 is a schematic view of a cleaning suction mode of the air conditioning device according to the embodiment of the present disclosure.

Referring to FIG. 7 together with FIGS. 2 to 5, an operational relationship and a control method in a case in which the cleaning suction button 162 of the air conditioning device according to the embodiment of the present disclosure is pressed will be described. First, one of the air conditioning mode button 161, the cleaning suction button 162, and the cleaning blowing button 163 is selected in the control panel, and then the air channel is adjusted according to a mode corresponding to the button selected from the air conditioning mode button 161, the cleaning suction button 162, and the cleaning blowing button 163, and when the cleaning suction button 162 is pressed, the suction door is opened, the indoor air suction channel is closed, and the exhaust door is closed.

Specifically, in the same structure described above, the suction door 132 selectively opens one of the outdoor air suction channel and the indoor air suction channel, and when the cleaning suction button 162 is pressed, the outdoor air suction channel is opened and the indoor air suction channel is closed.

Further, the exhaust channel is closed by closing the exhaust door 142 formed in the exhaust case 141 mounted in the exhaust part 140.

Accordingly, the air is introduced through the outdoor air suction channel communicating with one side of the suction case 131 as shown by an arrow, and flows into the interior through the main body 110 since the exhaust door 142 is closed.

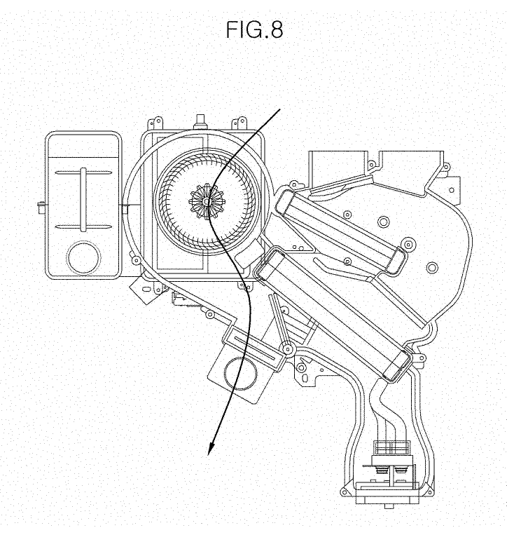

FIG. 8 is a schematic view of a cleaning blowing mode of the air conditioning device according to the embodiment of the present disclosure.

Referring to FIG. 8 together with FIGS. 2 to 5, an operational relationship and a control method in a case in which the cleaning blowing button 163 of the air conditioning device according to the embodiment of the present disclosure is pressed will be described. First, one of the air conditioning mode button 161, the cleaning suction button 162, and the cleaning blowing button 163 is selected in the control panel, and then the air channel is adjusted according to a mode corresponding to the button selected from the air conditioning mode button 161, the cleaning suction button 162, and the cleaning blowing button 163, and when the cleaning blowing button 163 is pressed, the suction door is closed, the indoor air suction channel is opened, and the exhaust door is opened.

Specifically, in the same structure described above, the suction door 132 selectively opens one of the outdoor air suction channel and the indoor air suction channel, and when the cleaning blowing button 163 is pressed, the outdoor air suction channel is closed and the indoor air suction channel is opened.

Further, the exhaust channel is opened by opening the exhaust door 142 of the exhaust case 141 mounted in the exhaust part 140.

Accordingly, the air is introduced through the outdoor air suction channel communicating with one side of the suction case 131 as shown by an arrow, and flows through the exhaust door 142 by operating the blower 120 since the exhaust door 142 is opened.

In accordance with the embodiment of the present disclosure, the air conditioning device for a vehicle and the control method thereof may simultaneously implement the air conditioning function and the cleaning function in the rear HVAC to improve convenience, and may reduce costs for separate cleaning equipment and reduce weight to improve operational efficiency and space utilization.

It may be understood by those skilled in the art to which the present disclosure pertains that the present disclosure may be implemented as other specific forms without changing the spirit or essential feature thereof. Therefore, it is to be noted that the embodiments described above merely are the most preferred embodiments selected from multiple applicable embodiments and suggested to help understanding of those skilled in the art and the technical idea of the present disclosure is not limited or restricted by the embodiment suggested above, and various changes, additions, and modifications may be made without departing from the technical idea of the present disclosure, and other equivalent embodiments may be possible. It should be interpreted that the scope of the present disclosure is defined by the following claims rather than the above-mentioned detailed description and all modifications or alterations deduced from the meaning, the scope, and equivalences of the claims are included in the scope of the present disclosure. In addition, terms and words used in the present specification and claims are defined based on a principle that the inventors can appropriately define the concepts of terms in order to describe their own disclosures in best mode and are not to be construed as only having a general or dictionary meaning. Further, the order of the configurations described in the above processes need not necessarily be performed in the temporal sequence, and as long as the gist of the present disclosure may be satisfied, even when the order of the respective configurations and steps is changed, the processes may belong to the scope of the present disclosure.

What is claimed is:

1. An air conditioning device for a vehicle, comprising:
a main body;
a blower provided in the main body;
a suction part connected to one side of the main body to draw in outdoor air; and
an exhaust part connected to the suction part to exhaust air.

2. The air conditioning device of claim 1, wherein the suction part includes a suction case, a suction door embedded in the suction case to selectively open or close a channel, a suction actuator configured to open or close the suction door, a dust container connected to the suction case, and a suction filter embedded in the dust container.

3. The air conditioning device of claim 2, wherein the suction door selectively opens one of an outdoor air suction channel and an indoor air suction channel.

4. The air conditioning device of claim 2, wherein the suction filter is a washable filter.

5. The air conditioning device of claim 2, wherein a suction hose connecting part is provided at the dust container.

6. The air conditioning device of claim 5, wherein the suction hose connecting part is formed with a first protrusion.

7. The air conditioning device of claim 5, wherein the suction hose connecting part is a rotation locking structure.

8. The air conditioning device of claim 2, wherein the suction part further includes a first cover covering the suction part.

9. The air conditioning device of claim 1, wherein the exhaust part includes an exhaust case, an exhaust door connected to the exhaust case to open or close an exhaust channel, an exhaust actuator configured to open or close the exhaust door, and an exhaust filter embedded in the exhaust case.

10. The air conditioning device of claim 9, wherein an exhaust hose connecting part is provided at the exhaust case.

11. The air conditioning device of claim 10, wherein the exhaust hose connecting part is formed with a second protrusion.

12. The air conditioning device of claim 10, wherein the exhaust hose connecting part is a rotation locking structure.

13. The air conditioning device of claim 9, wherein the exhaust part further includes a second cover covering the exhaust part.

14. The air conditioning device of claim 1, wherein a vacuum cleaner using the air conditioning device further includes a cleaning hose.

15. The air conditioning device of claim 1, wherein a vacuum cleaner using the air conditioning device further includes a control panel.

16. The air conditioning device of claim 15, wherein the control panel includes an air conditioning mode button, a cleaning suction button, and a cleaning blowing button.

17. A control method of a vacuum cleaner using an air conditioning device for a vehicle, the air conditioning device including a main body, a blower provided in the main body, a suction part connected to one side of the main body to draw in outdoor air; and an exhaust part connected to the suction part to exhaust air, the control method comprising the steps of:
selecting one of an air conditioning mode button, a cleaning suction button, and a cleaning blowing button in a control panel; and
adjusting an air channel according to a mode corresponding to the button selected from the air conditioning mode button, the cleaning suction button, and the cleaning blowing button.

18. The control method of claim 17, wherein in selecting step, when the air conditioning mode button is pressed, a suction door and an exhaust door are closed, and indoor air is introduced.

19. The control method of claim 17, wherein in the selecting step, when the cleaning suction button is pressed, a suction door is opened, an indoor air suction channel is closed, and an exhaust door is closed.

20. The control method of claim 17, wherein in the selecting step, when the cleaning blowing button is pressed, a suction door is closed, an indoor air suction channel is opened, and an exhaust door is opened.
